(19) United States
(12) Patent Application Publication
(10) Pub. No.: US 2007/0215299 A1
(43) Pub. Date: Sep. 20, 2007

(54) Roller Blind System

(75) Inventor: Manuel Eiselt, Rosenheim (DE)

Correspondence Address: ROBERTS, MLOTKOWSKI & HOBBES, P. O. BOX 10064, MCLEAN, VA, 22102-8064, US

(73) Assignee: WEBASTO AG, Stockdorf (DE)

(21) Appl. No.: 11/572,828

(22) PCT Filed: Jul. 25, 2005
(86) PCT No.: PCT/DE05/01319

§ 371 Date: Jan. 29, 2007

(30) Foreign Application Priority Data
Jul. 27, 2004 (DE) 10 2004 036 392.7

(51) Int. Cl. B60J 1/20

(52) U.S. Cl. 160/370.22

(57) ABSTRACT

A shade system for a motor vehicle with a shade web, one end of which is attached to a take-up tube (10) and the other of which is connected to a pull (14), with a take-up shaft (12) which is held coaxially in the take-up tube and is connected to the take-up tube by a torsion spring (16), a drive device for actuating the shade web having a gear (20) connected coaxially to the take-up shaft and a toothed-belt (18) which is connected to the pull. The toothed belt is an open, flexible toothed belt (18) which is guided in a compressively stiff manner in a guide rail (30) and has a first belt end (24) connected to the pull (14), and a second belt end which is deflected around the gear (20) in a direction toward the first end of the toothed belt.

### BACKGROUND OF THE INVENTION

1. Field of the Invention

This invention relates to a shade system with a shade web, one end of which is attached to a take-up tube and an opposite end of which is connected to a pull, with a take-up shaft which is held coaxially in a take-up tube and which is connected to the take-up tube via a torsion spring, and a drive device designed for actuating the shade web and having a gear connected coaxially to the take-up shaft and a toothed-belt which is connected to the pull.

2. Description of Related Art

A generic shade system of the initially mentioned type is known, for example, from German Patent DE 198 34 777 C2. The shade disclosed there has a shade web with one end attached to a take-up tube and with the other end provided with a pull. The shade web is taken up onto a take-up tube which coaxially holds a central take-up shaft which is connected to the take-up tube via a torsion spring in order to ensure a constant torque between the take-up tube and take-up shaft and thus constant pretensioning of the shade web for all drawn positions. The shade also has a drive device with a flexurally stiff and compressively stiff drive element, preferably a tension- and compression-stiff drive cable which acts on the pull of the shade and moves it. The drive element turns the take-up shaft and the take-up tube with the same rotational speed when the shade web moves. Instead of a drive cable, alternatively a rack or a toothed belt can be provided which drives the take-up shaft via a gear which meshes with the rack.

German Patent DE 198 44 779 C1 discloses a shade system in which to move the shade a conventional, compressively stiff threaded cable is used as the preferred displacement element. As an alternative, a toothed belt or rack arrangement is mentioned; however, no detailed explanation of how this toothed belt or rack arrangement would be configured is provided.

German Patent Application DE 101 55 167 A1 discloses a sunshade arrangement for a motor vehicle roof in which the take-up shaft is connected via a connection gear to the driven shaft of a drive motor located coaxially to the take-up shaft. Instead of a connection gear, the drive motor can have a planetary gear which is connected to the take-up shaft via a toothed belt.

German Patent Application DE 32 11 467 A1 discloses an opening system for a sliding roof for motor vehicles in which, in a conventional manner, there is a drive unit with a rotary output pinion which drives two tension- and compression-stiff driven elements which act on the two sides of the sliding roof cover in opposite directions to move the sliding roof cover. Instead of the otherwise conventional drive cable, there are toothed belts which are housed in a compressively stiff manner in a slide rail.

The disadvantage in the existing designs for driving a shade is that, due to the flexurally stiff drive cables or rigid racks or closed, revolving toothed belts which are used, a large installation space is necessary to house these elements in the x-direction (lengthwise axis of the vehicle) and/or z direction (vertical axis). For shades that have a long length that can be drawn out, the drive element in the guide rail also causes increased friction which leads to increased expenditure of force to move the shade. Furthermore, in the known designs with a rack and gear, only one tooth of the gear is ever completely engaged with the rack; this, on the one hand, leads to increased noise, and on the other hand, the operator can also sense when the shade is actuated and this leaves a poor-quality impression.

### SUMMARY OF THE INVENTION

In view of the above noted prior art, a primary object of this invention is to devise a shade of the initially mentioned type in which, on the one hand, the necessary installation space is as small as possible, and on the other hand, movement of the shade is allowed with as little expenditure of force as possible and ease of operation as high as possible.

This object is achieved by a shade system of the initially mentioned type in which the toothed belt is an open, flexible toothed belt which is guided in a compressively stiff manner in a guide rail and has a first belt end which is connected to the pull and a second belt end which is deflected around a gear in a direction toward the first end of the toothed belt.

In the design in accordance with the invention, it is advantageous that, by using a flexible, open, i.e., not closed, but finite toothed belt as the compressively stiff drive element and by deflection of this toothed belt around the gear, which can thus take place over a small radius, the required installation space is kept very small. In particular, the space which is otherwise necessary to hold the exit end of the element for nonflexible drive elements, like racks or stiff drive cables, is eliminated. This reduces installation space along the lengthwise axis of the vehicle (x-direction). In the vertical direction (z-direction), the installation depth is clearly reduced, since along the displacement path of the shade the toothed belt is guided twice, but with a shorter distance than in systems with two gears and a revolving toothed belt.

The deflection of a toothed belt around a gear in accordance with the invention can be carried out with much smaller radii that in existing shade systems with a deflected or wound tension- and compression-stiff drive cable. The design in accordance with the invention also offers the advantage that, in contrast to existing designs with racks, not only one tooth of the gear engages, but the gear can engage the toothed belt over a very large region of its periphery; this reduces noise development, and furthermore, perceptibly improves the impression of quality. Compared to systems with revolving toothed belts, the material cost is reduced (only one offset). Moreover, by using piece goods for the toothed belt, costs can be reduced, since the same toothed belts can be cut to size for different roofs.

Other preferred embodiments of the invention will become apparent from the following detailed description of the invention with reference to the accompanying drawings.

### BRIEF DESCRIPTION OF THE DRAWINGS

FIG. 1 is a schematic perspective of a portion of shade system in accordance with the invention; and

FIG. 2 is a side view of a portion of the shade system from FIG. 1 extending along the lengthwise axis of the vehicle.

### DETAILED DESCRIPTION OF THE INVENTION

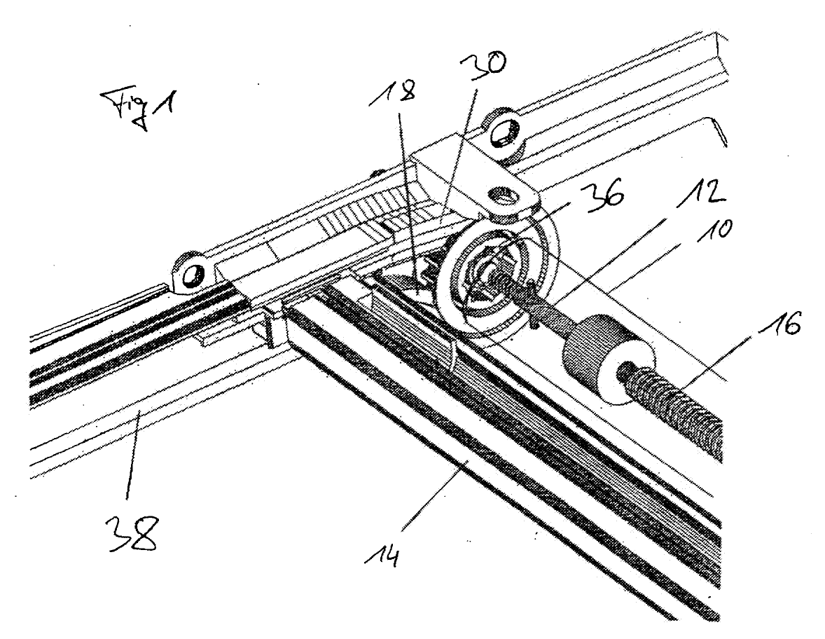

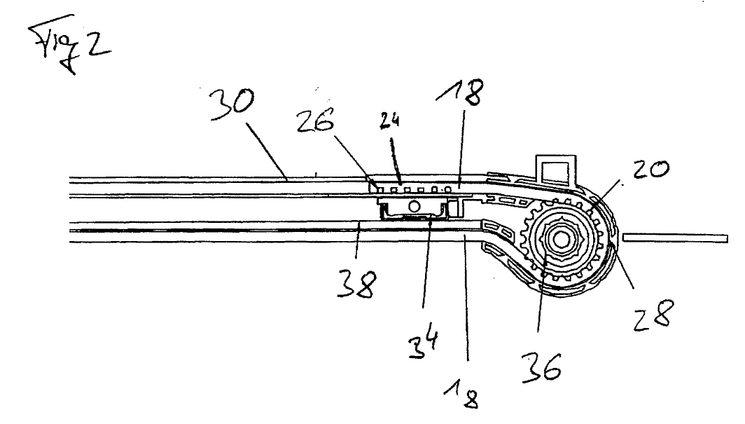

FIG. 1 shows a shade system in accordance with the invention for moving a shade web (not shown) which is installed such that it is attached at one end to a rotatably mounted take-up tube 10, which is shown only schematically in outline here. The other end of the shade web is connected to a pull 14 which is movably supported by means of a guide rail 38. Within the take-up tube 10, there is a central take-up shaft 12 which is connected to the take-up tube via only one torsion spring 16. In this embodiment, the take-up shaft is inserted into a star catch 36 which is, in turn, connected to a gear 20 (FIG. 2). This gear 20 engages an open (i.e., of finite length as contrasted with an endless or closed belt), flexible, movable toothed belt 18 which is supported in a compressively stiffly manner in a guide rail 30. While one end of the toothed belt 18 is loose, the other end 24 of the toothed belt 18 is connected by means of a link 26 to the pull 14 of the shade system. The shade web is mounted such that it is connected by its front edge to the pull 14 and by its rear edge to the take-up tube 10.

Since the pull 14, as described, is connected to the take-up shaft 12 via the toothed belt 18, the tension of the shade web can be adjusted by way of pretensioning of the torsion spring 16 which connects the take-up tube 10 and take-up shaft 12. If the pull 14, and with it the shade web, are pulled out by hand or by means of an electric motor, on the one hand, the shade web turns the take-up tube 10, and on the other, the toothed belt 18 turns the take-up shaft 12 via the gear 20. If the paths of rotation of the take-up tube 10 and take-up shaft 12 are the same, the torsion spring 16 remains in its original tension state. Thus, the torsion spring 16 can be adjusted such that it keeps the shade web at the desired tension. However, in contrast to systems without an additional moving take-up shaft, it cannot snap the shade web back when the pull 14 is released. Thus, the shade system remains in any desired position without additional holding devices.

According to the length of the shade web that has been drawn out, the toothed belt 18 in the guide rail 30 causes additional friction which must be overcome by means of additional force when the pull 14 is pushed back. If the diameter of the gear 20 is chosen to be greater than the diameter of the take-up shaft 12, including the completely wound shade web, when the shade is drawn (for example, by pulling manually on the pull 14), the take-up shaft and the gear are turned at different rpm due to their different diameters. Since the gear 20 is connected to the take-up shaft 12, thus relative motion between the take-up tube 10 of the take-up shaft 12 is induced which tensions the torsion spring 16 provided between the take-up tube 10 and the take-up shaft 12 beyond the “base tension” in the retracted state of the shade, more strongly, the greater the displacement path. When the shade is opened (i.e., when it is taken up), this additional tension is used to compensate for the higher actuating forces which are necessary when the shade has been completely drawn.

FIG. 2 shows a side view of the guide rails 30, 38 of the toothed belt 18 and pull 14, the latter being guided by means of a slider 34 in its guide rail 38. As is shown here, the toothed belt 18 in its guide rail 30 is routed around the gear 20 such that deflection by roughly 180° is achieved. The guide rail 30 of the toothed belt 18 is used to make the flexible, open (i.e. finite and not closed or endless) toothed belt compressively stiff. This compressive stiffness is necessary since different from an endless toothed belt, the toothed belt 18 is loaded not only with tension, but also with compression.

In order to keep the friction forces within limits in the 180° offset, the guide rail 30 is preferably equipped with a deflection guide 28 in the region of the gear 20. The material of the deflection guide 28 must be designed for a friction coefficient as small as possible, for which reason, here, POM (polyoximethylene) with a portion of PTFE (TEFLON®, polytetrafluorethylene) or with a silicone portion has proven effective. The link 26, as already mentioned, constitutes the connection between the toothed belt 18 and the pull 14, and can be injected-molded onto the toothed belt, or pressed, bonded or cemented to it. Preferably, link 26 has a toothed or grid shape which can be engaged by the teeth of the toothed belt 18.

What is claimed is:

1-9. (canceled)

10. Shade system for a motor vehicle, comprising:
a guide rail;
a take-up tube;
a shade pull;
a shade web, one end of which is attached to the take-up tube and an opposite end of which is connected to the pull,
a take-up shaft which is held coaxially in the take-up tube and which is connected to the take-up tube via a torsion spring, and
a drive device for actuating the shade web and having a gear connected coaxially to the take-up shaft and a toothed-belt which is connected to the pull;
wherein the toothed belt is an open, flexible toothed belt which is guided in a compressively stiff manner in the guide rail, has a first belt end which is connected to the pull and has a second belt end which is deflected around the gear in a direction to toward the first end of the toothed belt.

11. Shade system as claimed in claim 10, wherein the toothed belt is deflected around the gear by an angle between 170° and 270°.

12. Shade system as claimed in claim 11, wherein the toothed belt is deflected around the gear by an angle of about 180°.

13. Shade system as claimed in claim 10, wherein the pull is manually movable.

14. Shade system as claimed in claim 10, further comprising an electric motor for moving the pull.

15. Shade system as claimed claim 10, wherein the gear has a diameter that is larger than the diameter of the take-up tube with the shade web completely wound thereon.

16. Shade system as claimed in claim 10, wherein the pull is connected to the toothed belt via a link which is joined to the toothed belt by having been one of injected, pressed, bonded and cemented onto the toothed belt.

17. Shade system as claimed in claim 10, wherein the toothed belt is deflected around the gear by a deflection guide.

18. Shade system as claimed in claim 17, wherein the deflection guide is made of polyoximethylene with a portion of polytetrafluorethylene or silicone.

19. Shade system as claimed claim 11, wherein the gear has a diameter that is larger than the diameter of the take-up tube with the shade web completely wound thereon.

20. Shade system as claimed in claim 19, wherein the pull is connected to the toothed belt via a link which is joined to the toothed belt by having been one of injected, pressed, bonded and cemented onto the toothed belt.

21. Shade system as claimed in claim 19, wherein the toothed belt is deflected around the gear by a deflection guide.

22. Shade system as claimed in claim 21, wherein the deflection guide is made of polyoximethylene with a portion of polytetrafluorethylene or silicone.
